(19) United States
(12) Patent Application Publication
(10) Pub. No.: US 2023/0368700 A1
(43) Pub. Date: Nov. 16, 2023

(54) TACTILE DRAWING AND WRITING APPARATUS FOR THE VISUALLY IMPAIRED

(71) Applicant: TOUCHPAD PRO ASSISTIVE TECHNOLOGY LLC, Valhalla, NY (US)

(72) Inventor: Daniel LUBINER, Valhalla, NY (US)

(21) Appl. No.: 18/016,797

(22) PCT Filed: Jul. 23, 2021
(86) PCT No.: PCT/US2021/042885

§ 371 Date: Aug. 7, 2023

Related U.S. Application Data
(60) Provisional application No. 63/056,708, filed on Jul. 26, 2020.

(51) Int. Cl. G09B 21/00

(52) U.S. Cl. CPC G09B 21/004; G09B 21/002

(57) ABSTRACT

The disclosed device is useful in the instruction and practice of braille. Combined with a computer or smartphone app, the device has application to assist the vision impaired with learning of braille and in the creation of art in the classroom and in remote settings.

### CROSS-REFERENCE TO RELATED APPLICATION

This application claims the benefit of U.S. Provisional Application No. 63/056,708, filed Jul. 26, 2020, which is incorporated by reference.

### FIELD OF THE INVENTION

Embodiments of this invention relate to a tactile drawing apparatus and braille instruction devices. More particularly, the invention relates to a mechanical device for creating tactile drawings, and it is a braille teaching tool that, optionally, could have electronic components.

### BACKGROUND INFORMATION

Among the blind and low-vision community; only 32% graduate from high school, and fewer than 16% achieve a bachelor's degree or higher. Unemployment numbers remain steady at approximately 70%. Of the 30% of the blind population that does find employment, 90% are braille-literate. Nevertheless, despite the evident and undisputed value of braille, only about 10% of blind children are currently learning it. Thus, there is a need for engaging and effective devices for teaching braille to blind children and adults. Moreover, as distance learning has become the norm in places all over the world, instruction as we know it today may be impacted indefinitely. Therefore, devices such as disclosed herein, and corresponding “apps” for their use over the Internet, fulfill an urgent need.

Also, experiencing and creating art is challenging for the blind. Creating art with a refreshable surface has made for an enjoyable and educational toy. The present embodiments are designed specifically for those who are blind, deaf-blind or have low vision, to be both enjoyable and helpful, both in and out of the classroom.

Conventional devices for teaching braille suffer from various drawbacks. U.S. Patent Application Publication US 2012/0082313 describes an interactive system for braille learning, but it only allows the blind learner to form braille characters using a keyboard and not with a tactile interaction. U.S. Pat. No. 10,453,359 is an interactive system for teaching braille, but there is no keyboard, and the system uses of separate block for braille characters which is not easy for a blind learner to use. U.S. Patent Application US 2020/0242969, by the inventor herein, emphasizes tactile image creation and is not optimized for braille instruction. All of the foregoing disclosure are incorporated by reference, teaching those common features known to the person of ordinary skill in the art of making and using tools for teaching blind learners.

A better understanding of the present invention may become apparent from the following detailed description of arrangements and example embodiments and the claims when read in connection with the accompanying drawings—all forming a part of the disclosure of this invention. While the foregoing and following written and illustrated disclosure focuses on disclosing arrangements and example embodiments of the invention, it should be clearly understood that the same is by way of illustration and example only. The invention is not limited thereto.

### SUMMARY OF THE INVENTION

In one aspect, the invention is embodied as a tactile device for assisting the vision-impaired, comprising: a rigid surface comprising an array of holes in the surface, the holes each containing an element adapted to protrude from the surface in an up position and to hide below the surface in a down position; a stylus adapted to raise and lower the elements in the holes to the up position and the down position; the holes each containing a lock to secure the element in the up position against a predetermined level of force, to create a tactile effect.

In embodiments, the elements are metal or magnetic and may have a spheroid or spherical portion.

The lock in each of the holes may comprise a narrowing of a wall of the hole toward an opening of the hole, increasing friction on the element as the element moves toward the opening of the hole.

In alternative embodiments, the lock in each of the holes may comprise a spring-loaded mechanism, preventing the element from dropping in the up position. In embodiments, the locking mechanism comprises extra material within each hole the element has to pass through to lock the element in the up position.

In embodiments the stylus is magnetic and acts on a magnetic or metal element. In embodiments, the stylus may comprise an electromagnet. In embodiments, the device may further comprise a switch or dial on the electromagnet stylus to alter magnetic pull of the stylus on the element. In embodiments, the stylus maybe connected to the device by a retractable cord. In embodiments, the device comprises a storage place for the stylus.

In embodiments, the device is in the shape of a tablet and may further comprise a sleeve having cut-out portions, wherein the surface is received into the sleeve that fits snugly over the surface, such that the rectangular cutouts show a two by three array of holes to frame braille cells. Other shapes of cutouts are within the scope of the invention, including large cut outs to allow for making tactile drawings.

In embodiments, the holes are arranged in lines of braille cells, such as standard Perkins and jumbo Perkins cells, in which the “dots” of a 2×3 cell are separated by a specified amount and the distance between adjacent cells are likewise governed by Royal National Institute for the Blind (RNIB) standards. In embodiments, the surface is provided with a raised ridge providing tactile demarcation between adjacent braille cells.

In embodiments, lines of braille cells in the array are progressively smaller, so that one or more lines of standard Perkins cells could be followed by one or more lines of jumbo Perkins cells, for example.

In another embodiment according to the invention, a tactile device for assisting the vision impaired, comprises: an array of holes in a surface, each hole containing an element that protrudes from the surface in an up position and sits below the surface in a down position wherein the holes are arranged in 2 by 3 braille cells; a manual or automated mechanism configured to raise and lower the element within the hole to the up or down position; the holes each containing a lock to secure the element in the up position to create a tactile effect; a Perkins-style braille keyboard; and a processor configured to generate braille characters in the braille cells.

In embodiments, the tactile device may comprise different sizes of refreshable braille cells. Sensors may be provided within the holes that register if the element is in the up or down position. In this way a character or a set of characters may be locked in place, or the information transmitted or saved.

In embodiments for use by children, the Perkins Style braille keyboard is small-scale.

Embodiments of the invention comprise speakers and/or a headphone jack for audio feedback. As discussed below, the keyboard keys may comprising haptics or vibration motors within the keyboard of the device. These may be used to guide the hands of the user to the correct keystrokes.

The device may comprise a microphone for voice input and the processor may be adapted to respond to voice commands, and/or implement educational games (using voice recognition or otherwise), such as, without limitation, “Find the letter,” “Match that Sound,” “Spelling Bee,” and “Hangman”.

In embodiments, the device may be provided with a small tactile separation to distinguish one braille cell from the next. The device may comprising a USB port, may have Bluetooth capability and/or may be connected to the Internet via WiFi

Although typically provided with a stylus, it is within the scope of the invention to form braille characters in the braille cells only by voice or by keyboard, without a mechanical means for forming braille in the braille cells.

In embodiments, a device according to the invention is configured to connect to a smart phone or computer using an app. The app may be configured to generate braille characters remotely using the app installed on the smart phone or computer. The app may be configured to display a status of the device on a remote cell phone or computer.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a view of a device according to an embodiment of the invention, with its surface covered with holes placed tightly together and an attached stylus;

FIG. 2 is a side or cut-away view of 3 holes in a surface in an embodiment of the invention;

FIG. 3 is a view of a sleeve for a tablet-shaped device that slides over a surface according to an embodiment of the invention;

FIG. 4 is another view of a sleeve according to an embodiment of the invention;

FIG. 5 is a view the surface of a device received in the sleeve according to an embodiment of the invention;

FIG. 6 is a view of a device according to another embodiment of the invention, comprising three progressively smaller braille lines;

FIG. 7 is a rear view of another embodiment of the invention;

FIG. 8 depicts an electronic and mechanical device for braille instruction according to another embodiment of the invention;.

FIG. 9 is a rear view of a device incorporating different feature on the front and back of the device, according to embodiments of the invention;

FIG. 10 depicts creation of a desired tactile effect by using differently shaped tactile elements and a corresponding locking mechanism;

FIG. 11 is a close-up view of a “click pen” type mechanism for retaining elements in the holes;

FIG. 12 depicts a means of creating the desired tactile effect by using a “click pen” type mechanism; and

FIG. 13 is a means of creating the desired tactile effect by using a “push latch” type mechanism.

### DETAILED DESCRIPTION OF EMBODIMENTS

In the following detailed description, well-known methods, procedures, components, and circuits have not been described in detail so as not to unnecessarily obscure aspects of the invention. It should be apparent to one skilled in the art that the invention can be practiced without these specific details.

The surface of a device according to an embodiment of the invention illustrated in FIG. 1 is covered with an array of holes 1. The array of holes 1 may comprise hundreds of holes, placed tightly together. Each hole 1 contains an element, which may be a small metal or magnetic sphere or small cylindrical element. This element can be pulled to the surface by a stylus 2 and locked into place to create a tactile effect, such that the element can be touched and felt by a user. This “ [symbol] ” embodiment allows for the independent creation of tactile art on a surface that can be used repeatedly. Learners may make simple drawings and gain a better understanding of shapes and graphs.

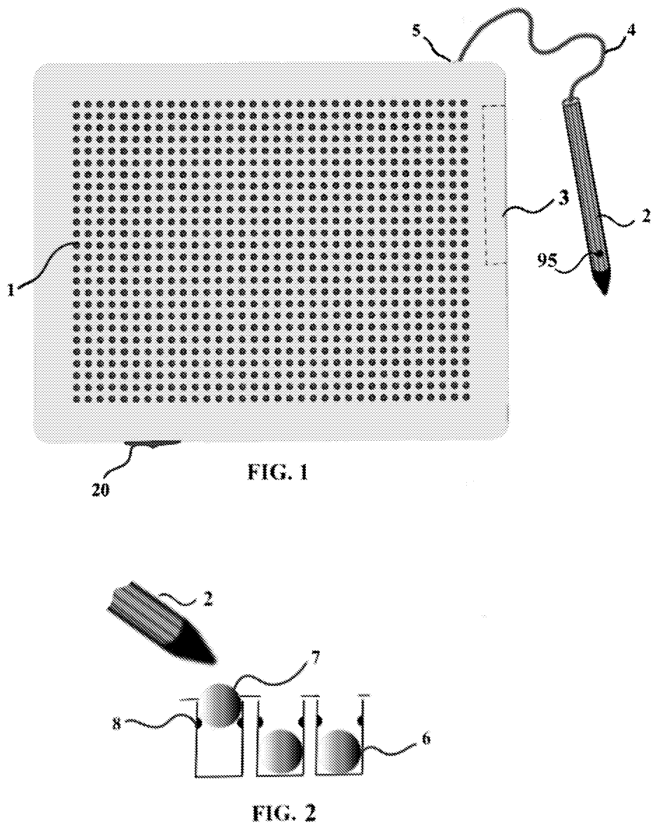

FIG. 2 illustrates how a metal element, such as sphere 7, may be held in an up position using a “friction trap” 8 or pushed into a down position at the bottom portion of hole or recess 6. Stylus 2 may be provided with a magnet to pull the spheres to the surface, allowing users to draw and make letters in braille or simply make tactile designs. Learners may also gain a better understanding of shapes and graphs. The magnet in stylus 2 could also be an electromagnet that is activated by a button 95. A sliding switch or dial (not shown) on an electromagnet stylus may alter the magnet's pull allowing for a more personalized effect. This stylus, powered with a small battery, may improve the user's ability to more accurately select a single sphere according to embodiments of the invention.

This embodiment, sometimes referred to as “ [symbol] ” (also referred to as BrailleDoodle), will be entertaining and instructional to those who are blind, deaf-blind, or have low vision; it will also be very affordable and easy to maintain. Because the cost to manufacture such a device is low, it would not be unreasonable to imagine Device One retailing for under USD $40. Also, since there are no required electronics in Device One, no electric components will be necessary. The option for an electromagnet in the stylus is accomplished with a simple design and AA battery.

Several innovations make Device One useful to the blind and low-vision users. The “friction trap” is strong enough to allow users to gently touch what they have created without the spheres dropping. However, the user should be able to erase a creation by pushing the spheres back down at a predetermined force with a satisfying “pop.” This force may be created with a finger or the top or side of the stylus for example.

The “friction trap” may be created by slightly narrowing the hole close to the top, or having a bit of extra plastic, creating a thinner passage for the element to pass through as it is pulled to up position 21. Another way may be to use spring plunger 8 to hold the spheres in an up position. Another possibility would be a switch 20 on the device that would slide a plate under the spheres to lock them in place. Other means of creating the desired tactile effect are described below.

In embodiments, Device One comprises a stylus connected to the device by a retractable cord 4 using a retracting mechanism inside the device 5. The retracting mechanism (which are used for example in vacuum cleaners and other home appliances, as would be known to a person having ordinary skill in the art) has two states: in the first, the cord is not under tension, allowing the user free use of the stylus; and in the second state, it pulls the stylus back in. This allows for freedom of movement while allowing for the stylus not to be lost. It is easy to drop something like a stylus, and it can be challenging for a blind or low-vision user to find. The device also has a storage place 3 for the stylus on the side for added convenience and portability.

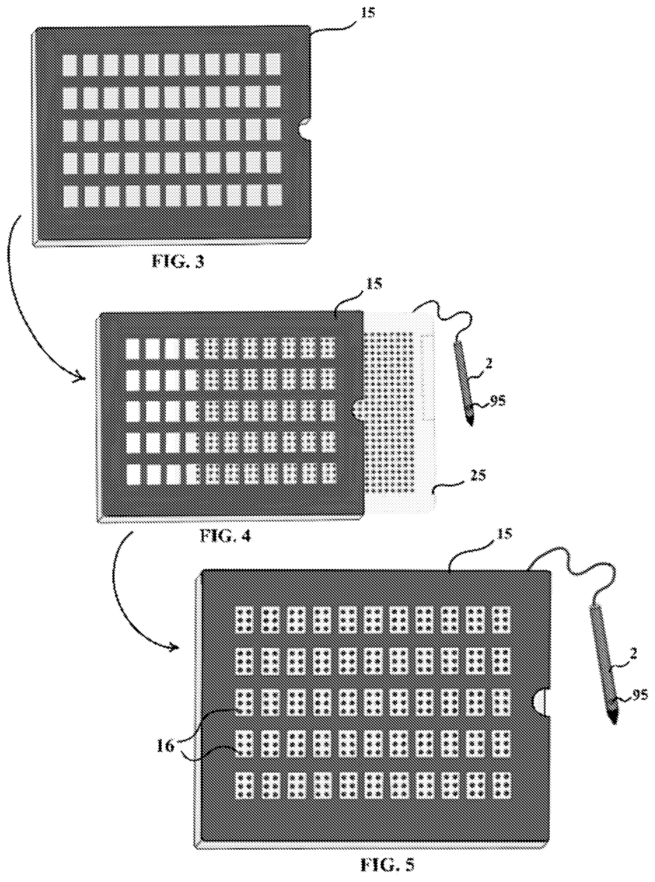

In the embodiment shown in FIG. 3, Device One may feature a sleeve or cover 15 shaped like a rectangular prism closed on three sides. Sleeve or cover 15 may be made of flexible material such as plastic and may conform to the device's dimensions so that Device One 25 fits snugly inside, as illustrated in FIG. 4. Sleeve 15 may comprise dozens of evenly spaced rectangular cutouts that cover the device's surface, as shown on FIG. 5. Each cutout may thus comprise a braille cell 16 of six “dot positions” that are arranged two by three. A different combination of raised dots can represent all letters and numbers. Hence, each rectangle will represent a braille cell 16. The user can then use the stylus 2 to raise the metal spheres (or other element) to create the raised dots in any combination to represent a letter or number. It may be preferable to raise all six spheres and push down those that do not belong in a given braille character—thereby allowing the user to feel their way to the correct combination.

A number of such rectangular cutouts, for example six or more rectangles, cells, will comprise a row, and there will be four or more rows. In each row, a word can be spelled out and felt by the user. Since this is a device intended to be used by beginning braille learners, namely children, spelling out short words or small sentences, is useful. For example, a student can spell out a short sentence such as “Now braille is fun!” For both art and braille, there are few tools that would be this affordable and simplistic to operate.

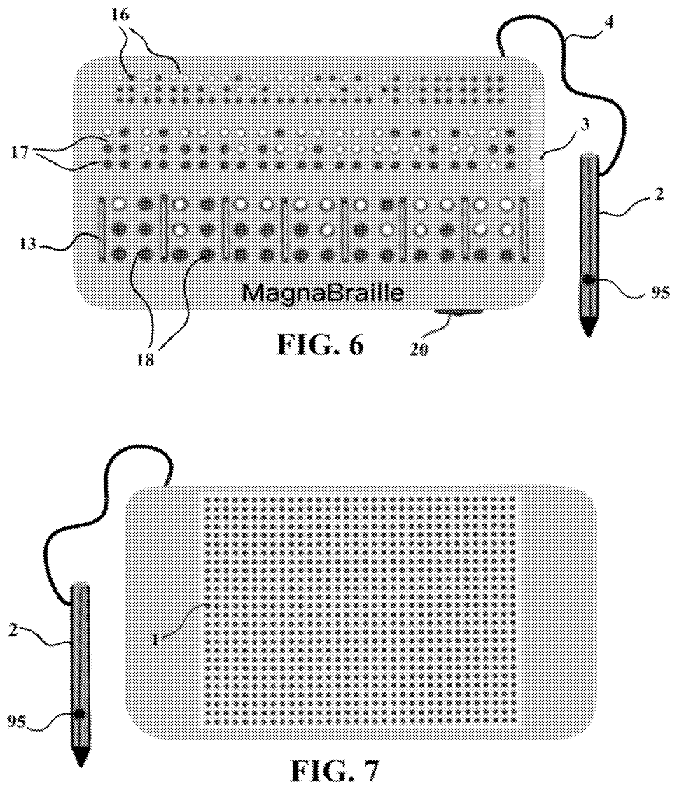

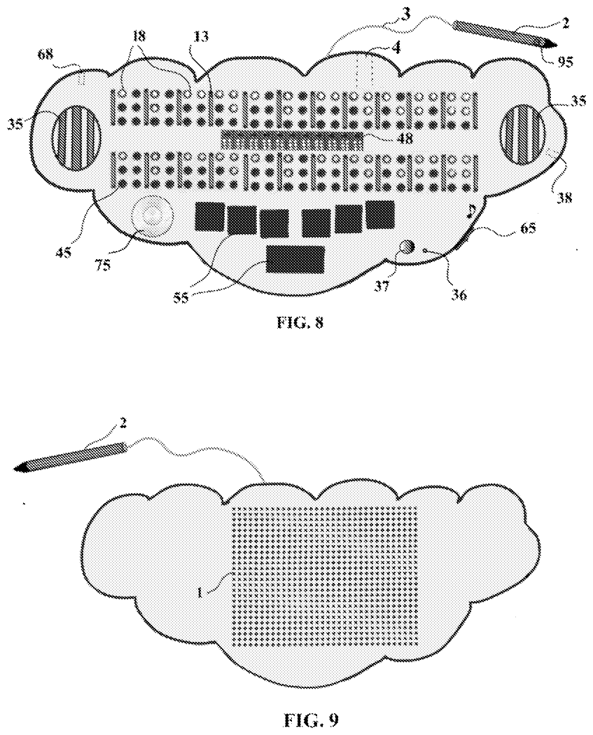

Another embodiment, sometimes referred to herein as “ [symbol] ” (or MagnaBraille), depicted in FIG. 6, is similar to Device One in that it may be made as a purely mechanical device that uses only magnets and tiny metal or magnetized spheres or similar elements. However, Device Two is made more for the instruction and practice of braille. It is a device that enables the user to form and erase braille numbers, letters, and words in a way that is motivational and fun, like playing on a toy to learn. A unique aspect of Device Two is how the learner can form and experience a large version of a particular braille letter or number to understand spatial relations and placements of the “dots.” Learners can then mimic the braille in a progressively smaller way from a large cell 18. to a medium-sized cell 17, to a small braille cell 16. The small braille cell would be close in size to the “Perkin's Standard” or “Perkin' s Jumbo” braille cell and would be able to be read with one finger. These are standard measurements for braille cells and would be known to the person of ordinary skill in the art of braille instruction. Ridges 13 may separate the large braille cells so that the early learner can easily distinguish one braille cell from the next.

The stylus 2 pulls the spheres to the surface, attached by a retractable cord 4 and stored in a storage place 3, allowing users to form braille letters. The stylus, as mentioned above, could also be electromagnetic that is activated by a button 95. An electromagnetic stylus may improve the user's ability to more accurately select an individual sphere. A switch on the bottom 20 can activate a mechanical locking mechanism.

Though a user could work independently with Device Two, the device may be used in an instructional setting, wherein an instructor may offer examples of letters, numbers, and words. Then the learner could feel the examples and copy and practice them. However, if the need presents itself, an instructor may guide the learner over video conferencing as to which spheres to raise to form the braille. Ideally, a person learns by doing, and Device Two would offer this. In embodiments, features of Device One may be placed on one side of the surface and Device Two on an opposite side, as pictured in FIG. 7. The already-available stylus 2 can draw on the array of hundreds of holes 1, just as described on Device One.

FIG. 8 depicts another embodiment sometimes referred to as “ [symbol] ” or The Braille Cloud. As pictured in FIG. 8, in this embodiment, an electronic apparatus is designed for the independent, classroom, and distance learning of braille. It offers a way for the autonomous, self-correcting, learning of braille, and braille keyboarding. The [symbol] solves some of the problems associated with known devices for implementing braille instruction, in particular the prior art fails to combine a keyboard to write braille with braille cells that can be touched and read by the user.

Large braille cells 45 and standard braille cells 48 are commonly known as Refreshable braille cells. Refreshable braille consists of a series of electronically-driven pins that pop up to form braille characters in response to instructions from the processor. The braille character can be removed and “refreshed” with a different braille character. Braille displays and note-takers, devices that utilize a line of refreshable braille, has become the prevailing piece of assistive technology for braille readers. Therefore, Device Three allows young children to begin to master reading standard-sized braille while gaining an understanding of how to use the more complex refreshable devices. Device Three offers a head start in learning to use refreshable braille devices that will play a significant role in the user's future in both education and employment.

A small Perkins-style braille keyboard 55 may be made for smaller hands. A learner may use the keyboard to learn the proper combination of keys to press to form a letter, word, or sentence. A learner can receive auditory feedback from speakers 35 or through a headphone jack 38. The braille version of a letter may be electronically formed in the large/jumbo refreshable braille cell 45 and the standard sized braille cell 48.

Haptics can also be placed within keyboard keys 55, so vibrations can guide fingers to press the correct keys. In the embodiment pictured, there are eleven large and corresponding standard braille cells, but that number may vary. Whatever is displayed on the large braille cells, 45 will be displayed on the standard sized 48. For example, the learner could key in the letter ‘A,’ hear audio feedback like the sound ‘A’ makes, and feel the braille ‘A’ in both the large and standard cells. Illustrated on FIG. 8 are letters ‘a’ through ‘k’ in braille.

With the above features, a learner can develop keyboarding skills while learning how the standard braille letters feel. Device Three may have games built right into the system to reinforce braille learning. Games will have “happy” sounds and a friendly human voice encouraging learners to succeed. Changes to the braille characters will be automated. “Find the letter,” “Match that Sound,” “Spelling Bee,” “Hangman” type games can be among some games that this embodiment may be adapted to perform with the device.

In FIG. 8, switch 65 turns the device and its sounds on and off. A charging port 68 for an on-board rechargeable battery may be provided. Optionally, regular batteries could be used. A video-game type controller 75 with clear up, down, right, left, and a select button is useful to toggle through options or the next line or word. As mentioned earlier, small ridges 13 separate the large braille cells so that the early learner can easily distinguish one braille cell from the next. A USB port may allow Device Three to hook up to a computer to download updates or make option changes. Bluetooth and Wi-Fi will allow for wireless connectivity.

A microphone 36 may allow users or adults to record their own sounds or words to correspond with specific actions. This will also provide for “ [symbol] ” to become multi-lingual by allowing a parent or instructor to alter the sounds made by the different actions and activities. A ‘talk to text,’ or in this case, ‘talk to braille,’ option could be activated with button 37 so that the user could say a word or letter and have it appeared in braille on the refreshable braille cells.

Voice commands may also be valuable with voice-recognition and AI software, like that of a voice-controlled digital assistance, such as SIRI®, or ALEXA® incorporated in the device. This offers another avenue for the autonomous, self-correcting, learning of braille. For example, a learner could say, “Cloud, let's play hangman,’ or, “Cloud, show me the word ‘excellent.’”

The upper row of large braille cells 18 is described in “Device Two.” The magnetic stylus 2 is attached to Device Three by a retractable cord 3 and stored in the built-in storage area 4. Like the other devices, the magnetic stylus allows users to make braille letters, numbers, words, and short sentences. In this way, the learner can mimic the braille letters formed in the lower lines. Learning by doing is considered among the most effective modes of instruction. As stated above, the stylus could also be an electromagnet that is activated by a button 95. This should improve the user's ability to more accurately select a single element. Sensors in the large magnetic braille holes 18 can effectively translate to the on-board computer and app what letters are being formed by the user. The user can then receive direct and immediate feedback from the instructor or the device itself.

Another feature of Device Three is that it can also be linked to a (Braille Cloud) App. This application is designed so that an instructor or an adult can remotely guide the user through the different features and games using an app installed on a smart phone or computer. For example, an instructor can input a word or letter from their personal device: phone, tablet, or computer for a learner to decode on the device. Alternatively, the instructor may ask the learner to use the keyboard for input and get feedback immediately on his or her phone through the app for correcting. In embodiments, an instructor can also begin a game for the learner and play along using the app on their personal device. The app is configured to display a simple diagram of the “ [symbol] ” on the screen of the instructor's device to give immediate feedback as to which keys are pressed and what braille pins are displayed. The device may be adapted so that an instructor may activate haptics within the keys to guide the learner's hands to the right keys.

In the foregoing, discussions utilizing terms such as, for example, “app,” “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other non-transitory information storage medium that may store instructions to perform operations and/or processes.

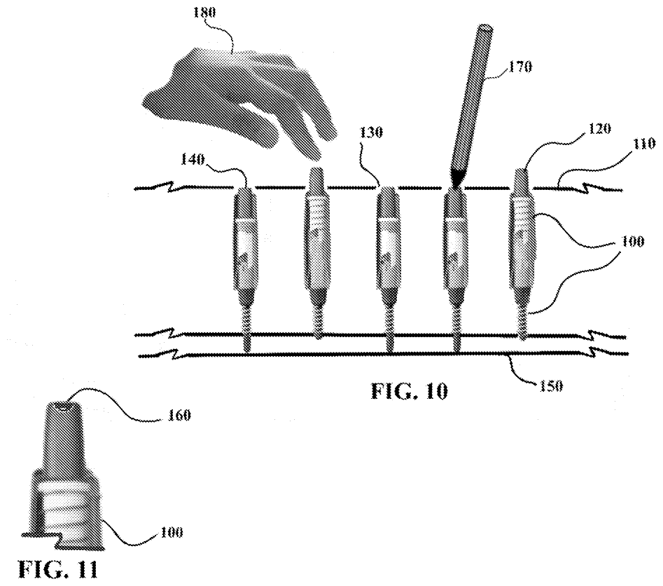

FIG. 10 illustrates another mechanism to achieve the writing and erasing of braille and making of tactile drawings (“Click Braille”). The mechanical features 100 are derived from the well-known retractable “click” pen 100. Small plungers and springs keep the diameter from 3 mm to 5 mm which are placed tightly together to achieve the desired effect, as illustrated in FIG. 1, FIG. 6, and FIG. 7.

As in the above embodiments, holes 130 in device surface 110 allow elements to protrude therefrom. Plate 150 with smaller holes allows piston 160 to move through it while the spring is held in place, mimicking the tip of a retractable pen. The plunger in its up position 120 makes for a tactile effect. The plunger in its down position 140 is flush with the surface. Because the plunger would be flush to the surface, a stylus 170, in this case, not magnetic, would be used to select and press down a plunger to raise it to the up position.

User's hand 180 indicates the user's fingers that can touch the tactile surface. Also, pressing the plunger to its down position can be achieved by using a finger or the stylus. The close-up view of the plunger in FIG. 11 illustrates the indention at the top of the plunger 160. This will match the stylus's tip and enable the user to find where to place the stylus to push the plunger to its up position or down again.

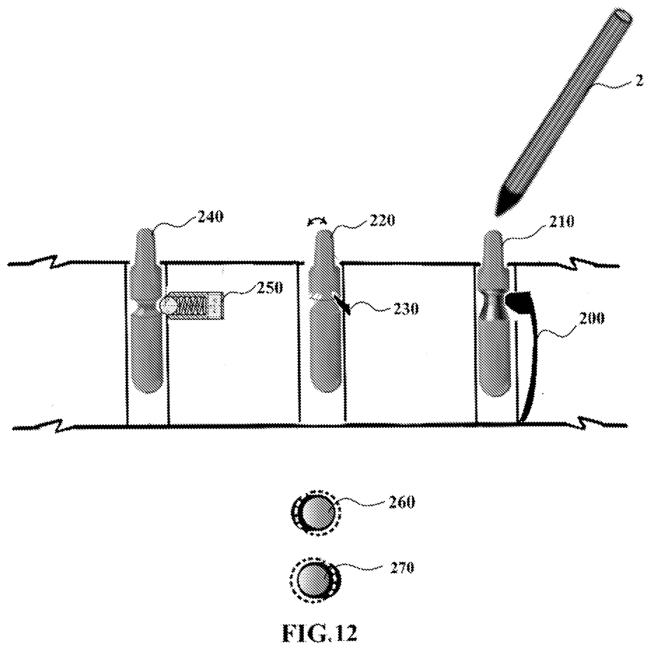

Another means of creating the desired tactile effect is illustrated in FIG. 12. The unique aspect of the element shape 220 is that only gravity and the magnetic stylus 2 are needed. The stylus lifts the element and moves it slightly to transfer it a locked up position to a down position. Top views of element 220 are seen in the up position 260 and down position 270. The shape of element 210 allows a simple spring 200 to lock the element in either the up or down position. When the magnetized stylus pulls the element up, the unique shaped spring locks it the up position. The element 240 has a semicircle cutout and uses a spring plunger 250 to lock the element in either the up or down position. A finger or the back of the stylus can push element 210 or 240 to the down position. An advantage of elements 210 and 240 are their ability to be locked in the down position. The device can then be carried, tilted, and turned over without the elements shaking and retracting from the surface. Note that elements maintain their shape and are lockable even if they are spun around.

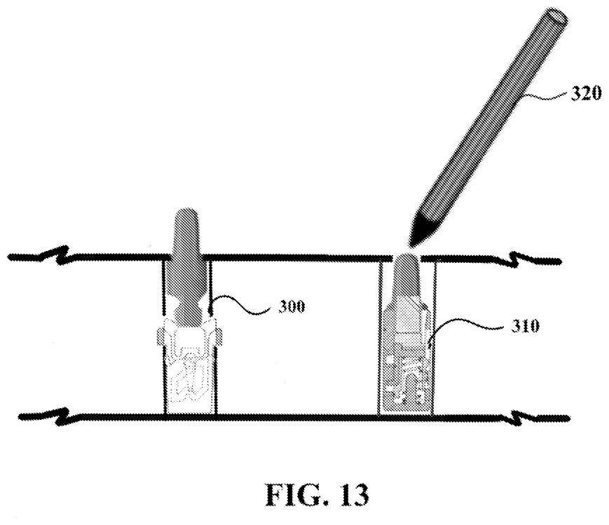

Depicted in FIG. 13 is another means of accomplishing the desired effect with a “Push Latch Device.” Several existing devices refer to a small spring powered apparatus that can be pushed in to lock an element inside the device and pushed again to release it. Two examples of these technologies, and how they can be utilized in the present invention, are shown in element 300 and element 310. The “push latch” is often used to open and close small doors like on kitchen cabinets or smaller doors on electronics where handles are not wanted. For example, a cabinet door would be pushed closed and held in place by a small magnet, then pushed again to gently spring open. This type of mechanism would be useful in the present invention by allowing the user to create a tactile effect, as described above. Stylus 320 would not require a magnet and would be used to press elements when they are flush to the surface.

1. A tactile device for assisting the vision-impaired, comprising:
a rigid surface comprising an array of holes in the surface, the holes each containing an element adapted to protrude from the surface in an up position and to hide below the surface in a down position;
a stylus adapted to raise and lower the elements in the holes to the up position and the down position;
the holes each containing a lock to secure the element in the up position against a predetermined level of force, to create a tactile effect; and
wherein the relative position of raised elements comprises braille characters.

2. (canceled)

3. The device according to claim 1, wherein the elements have a spheroid or spherical portion.

4. The device according to claim 1, wherein the lock in each of the holes comprises a narrowing of a wall of the hole toward an opening of the hole, increasing friction on the element as the element moves toward the opening of the hole.

5. The device according to claim 1, wherein the lock in each of the holes is a spring-loaded mechanism, preventing the element from dropping in the up position.

6. The tactile according to claim 1, comprising extra material within each hole the element has to pass through to lock the element in the up position.

7. The device according to claim 1, wherein the stylus is magnetic and acts on a magnetic or metal element.

8. (canceled)

9. The device according to claim 8, further comprising a switch or dial on the electromagnet stylus to alter magnetic pull of the stylus on the element.

10. The device according to claim 1, wherein the stylus is connected to the device by a cord.

11. (canceled)

12. (canceled)

13. (canceled)

14. The device according to claim 1, wherein the holes are arranged in lines of braille cells.

15. device according to claim 14, wherein the surface is provided with a raised ridge providing tactile demarcation between adjacent braille cells.

16. The device according to claim 14, wherein the lines of braille cells in the array are progressively smaller.

17. A tactile device for assisting the vision impaired, comprising:
an array of holes in a surface, each hole containing an element that protrudes from the surface in an up position and sits below the surface in a down position wherein the holes are arranged in 2 by 3 braille cells;
a manual or automated mechanism configured to raise and lower the element within the hole to the up or down position;
the holes each containing a lock to secure the element in the up position to create a tactile effect;
a Perkins-style braille keyboard; and
a processor configured to generate braille characters in the braille cells.

18. The tactile device of claim 17, wherein there are different sizes of refreshable braille cells.

19. The tactile device of claim 17, comprising sensors within the holes that register if the element is in the up or down position.

20. (canceled)

21. (canceled)

22. The tactile device of claim 17, comprising haptics or vibration motors within the keyboard of the device.

23. (canceled)

24. (canceled)

25. (canceled)

26. The tactile device of claim 17, comprising a small tactile separation to distinguish one braille cell from the next.

27. (canceled)

28. (canceled)

29. The tactile device of claim 17, wherein the processor is configured to perform actions or create braille characters based on voice commands received by the device.

30. (canceled)

31. (canceled)

32. (canceled)

33. The tactile device of claim 17, wherein the element within each hole is metal or magnetic spheres, cylinders or pellets.

34. The tactile device of claim 17, comprising a bottleneck design to retain elements in the up position in the hole.

35. The tactile device of claim 17, wherein each element is provided with a spring locking element to prevent the element from dropping.

36. The tactile device of claim 17, wherein each element is provided with extra material within the hole the element has to pass through to prevent the element from dropping.

37. The tactile device of claim 17, comprising a notch cut into each element and a clip from which the element hangs.

38. (canceled)

39. (canceled)

40. (canceled)

41. The tactile device of claim 17, wherein the device is configured to receive inputs from an app installed on a smart phone or computer that causes the device to generate braille characters.

42. The tactile device of claim 41, wherein the app is configured to display status of the device on the smart phone or computer.
